(19) United States
(12) Patent Application Publication
(10) Pub. No.: US 2025/0074040 A1
(43) Pub. Date: Mar. 6, 2025

(54) THERMOPLASTIC POLYOLEFIN ROOFING MEMBRANE FORMULATION WITH IMPROVED INDUCTION WELDING PERFORMANCE

(71) Applicant: CARLISLE CONSTRUCTION MATERIALS, LLC, Carlisle, PA (US)

(72) Inventors: Xuan ZHANG, Carlisle, PA (US); Daniel GIFFEN, Carlisle, PA (US); James GAGE, Boiling Springs, PA (US)

(73) Assignee: CARLISLE CONSTRUCTION MATERIALS, LLC, Carlisle, PA (US)

(21) Appl. No.: 18/822,979

(22) Filed: Sep. 3, 2024

Related U.S. Application Data
(60) Provisional application No. 63/536,814, filed on Sep. 6, 2023.

(51) Int. Cl. B32B 27/12; B32B 27/32; E04D 5/00

(52) U.S. Cl. CPC B32B 27/12; B32B 27/32; E04D 5/00; B32B 2307/546

(57) ABSTRACT

A TPO roofing membrane formulated to have enhanced induction welding properties, including: a TPO roofing membrane, with: a top TPO layer, a middle scrim layer, and a bottom TPO layer; and elastomeric additives added to the TPO membrane, wherein the elastomeric additives increase induction welding performance of the TPO membrane, and wherein elastomeric additives include polypropylene-based (C3) elastomers and polyethylene-based (C2) elastomers.

### RELATED APPLICATION

The present application claims priority to U.S. Provisional Patent Application Ser. No. 63/536,814, of same title, filed Sep. 6, 2023, the entire disclosure of which is incorporated herein by reference in its entirety for all purposes.

### TECHNICAL FIELD

The present invention relates to systems for improving the induction welding of Thermoplastic Polyolefin (TPO) roofing membranes to roofing anchor plates mounted below.

### BACKGROUND OF THE INVENTION

Thermoplastic Polyolefin (TPO) membranes have been used in roofing applications for many years. Various approaches have been used to attach these TPO membranes onto building roofs. Traditionally, TPO membranes have simply been attached to roofs by gluing them directly to the insulation boards or by gluing them to anchor pads that have been attached to the insulation boards. In other approaches, the edges of the TPO membranes are attached to mechanical fasteners on the insulation boards. Induction heating systems have also been used. In induction heating approaches, anchor discs are placed on top of the insulation boards. These anchor discs are covered with a powdered metallic substance which (when heated) turns into an adhesive that secures the TPO membrane on top of the insulation boards.

More recently, it has been desirable to design TPO membrane attachment induction welding systems that do not puncture the TPO membrane at all during its installation. The Rhino Bond® system sold by OMG, Inc. of Agawam, MA provides such as system, and is described in detail in U.S. Pat. Nos. 10,925,124 and 8,492,683. In these systems, an induction welding system is used. First, mechanical fasteners (called “anchor plates”) are attached across the roof in an array formation. Next, a TPO membrane is laid over the anchor plates and then the membrane is then welded to the anchor plates using a magnetic induction heating system. To locate these anchor plates below the TPO membrane, an operator passes a stand-up induction welding tool over the TPO membrane. This tool has sensor coils that detect the presence of the anchor plates below the membrane. When an anchor plate has been detected, the tool then uses magnetic induction to heat a heat-activated adhesive that covers the top of each anchor plate. When heated, the anchor plate's adhesive is then thermally welded to the bottom of the TPO membrane.

Although the Rhino Bond® system (and similar induction welding systems generally) have been found to be a fairly good solution, it is still desirable to continue to improve adhesion between the anchor plates and the bottom of the TPO membrane. This is because creating stronger adhesive bonding between anchor plates and the TPO membrane is particularly desirable when dealing with the problem of high winds. Specifically, higher winds will exert greater forces on the TPO membrane, possibly causing it to pull up and separate from the adhesives covering the tops of the anchor plates. Therefore, altering the formulation of either the adhesive on the top of the anchor plate or the TPO membrane itself to increase adhesion is desired as it will enable the roof to perform acceptably under higher winds, thus increasing the wind rating for the roof.

### SUMMARY OF THE INVENTION

The present invention provides a TPO roofing membrane that has been specifically formulated to be ideally suited to induction welding, and in particular to induction welding to anchor plates installed on the top of a building roof. In particular, the present TPO membrane has been formulated to have preferred amounts of specific elastomeric polymers added to either or both of the top and bottom layers of a TPO membrane.

In preferred aspects, the TPO membrane has a top TPO layer, a middle scrim layer and a bottom TPO layer. Also in preferred aspects, the elastomeric polymers that are added to the TPO layers are either or both of polypropylene-based (C3) elastomers or polyethylene-based (C2) elastomers. In various formulations disclosed herein, the elastomeric polymers may be added only to the bottom TPO layer, or more preferably to both the top and bottom TPO layers.

In preferred aspects, the polypropylene-based (C3) elastomers are added to the TPO membrane in a concentration of 5% to 70% of elastomer percent in total polymer. In more preferred aspects, the (C3) concentration would be 10% to 60%, and in most preferred aspects, the concentration would be 20% to 50%.

In other preferred aspects, both polypropylene-based (C3) elastomers and polyethylene-based (C2) elastomers are added together to the TPO membrane in a concentration of 5% to 70% of elastomer percent in total polymer. In more preferred aspects, the (C3)+(C2) concentration would be 10% to 60%, and in most preferred aspects, the (C3)+(C2) concentration would be 20% to 50%.

In other preferred aspects, only (C2) polymers are added together in the above concentrations.

The present inventors have experimentally determined that the addition of such preferred elastomeric polymers in such preferred percentage ranges has been found to significantly increase adhesion to induction welding anchor plates. A selection of such experimental data is presented herein.

### BRIEF DESCRIPTION OF THE DRAWINGS

FIG. 1A is a perspective view of a layered TPO membrane.

FIG. 1B is a sectional side elevation view showing a fastener and RhinoBond® plate securing a TPO membrane to insulation boards below.

FIG. 2A is an illustration of a mechanically fastened TPO membrane installed on a roof.

FIG. 2B is an illustration of a fully adhered TPO membrane installed on a roof.

FIG. 3A is an illustration of an adhesion strength test about to be performed on an anchor plate induction welded to the bottom of a TPO membrane in which the anchor plate is pulled away from the TPO membrane.

FIG. 3B is an illustration after the test in FIG. 3A has been performed in which the anchor plate has been fully separated from the TPO membrane.

FIG. 4A is an illustration of wind uplift testing of a TPO membrane affixed to a roof by an array of anchor plates.

FIG. 4B is an illustration of wind uplift testing of a TPO membrane affixed to a roof using only traditional in-seam fastening.

### DETAILED DESCRIPTION OF THE DRAWINGS

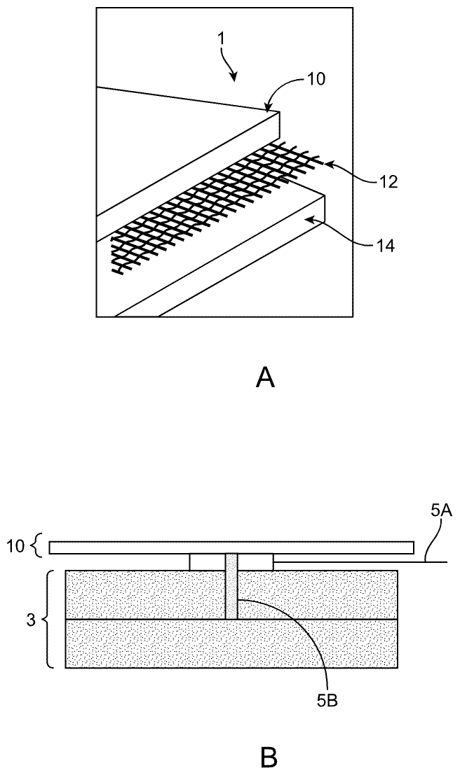

FIG. 1A is an illustration of a standard layered TPO membrane 1. As can be seen, a standard TPO membrane comprises a top ply layer 10 and a bottom ply layer 14 preferably separated by a reinforced scrim 12. Industry-standard TPO roofing membranes 1 are typically a composite structure containing a top TPO layer (20-50 mils thick), a reinforcing polyester scrim fabric (1-2 mils thick), and a bottom TPO layer (20-50 mils thick). Most TPO membranes have a width of 6-12 feet. Recently, 16 feet wide TPO roofing membrane has been introduced into the marketplace. TPO sheets are typically sold in rolls. During the roof installation, several sheets are unrolled at the installation site and placed next to one another covering the roof. Finally, overlapping edge seams are joined together using a heat welding process to form a monolithic sheet that covers the roof.

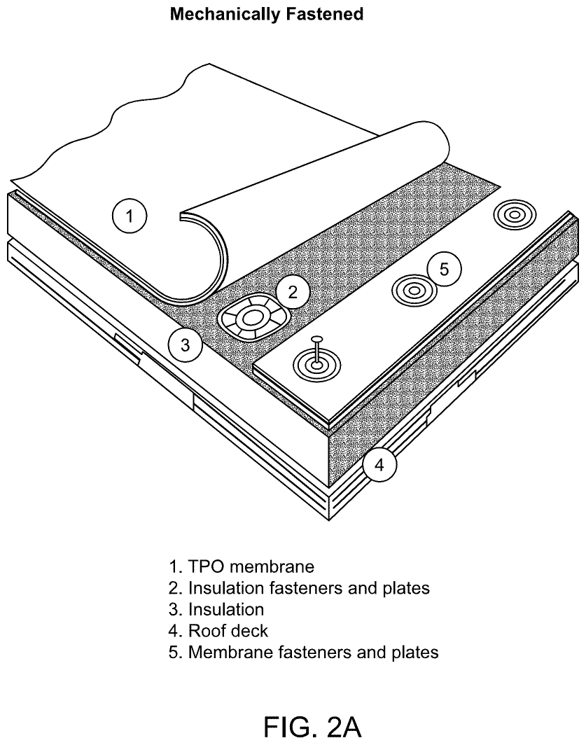

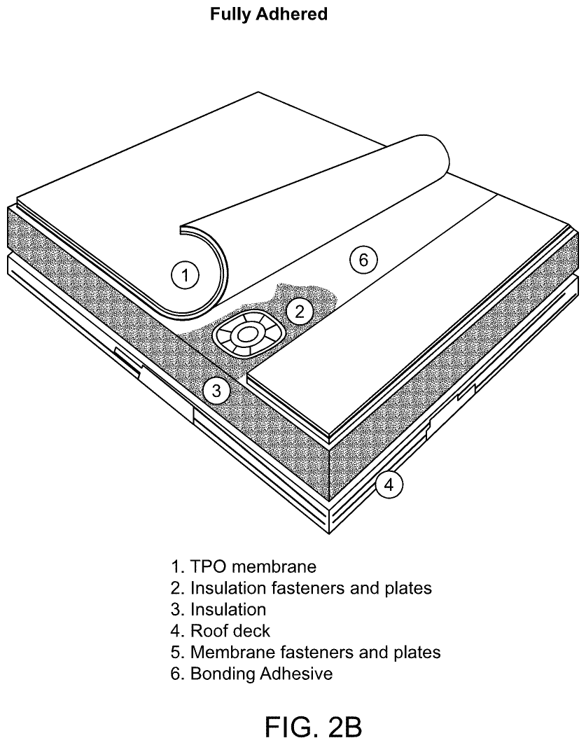

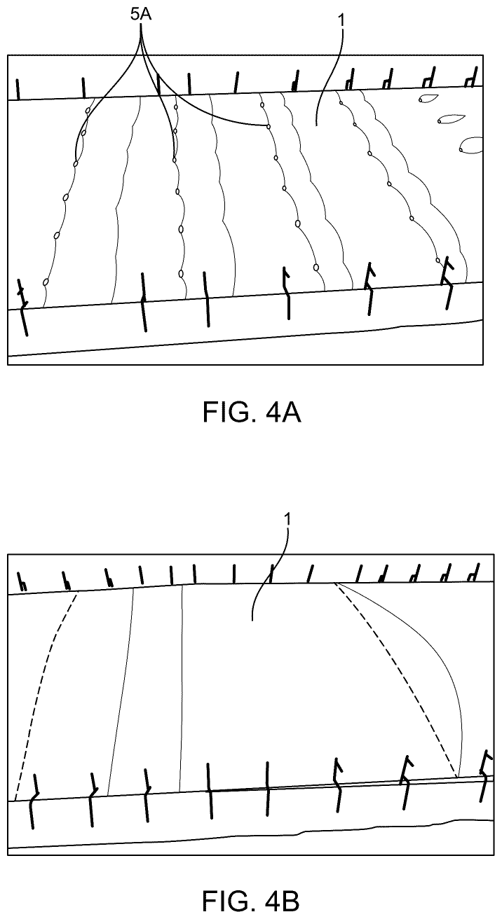

FIG. 2A is an illustration of a mechanically fastened TPO membrane 1 installed on a roof. In this Figure, the insulation layer 3 is secured down to the roof deck 4 by fasteners and plates 2. Next, traditional membrane fasteners and plates 5 are installed along an edge of the insulation 3 as shown. The TPO membrane 1 is then attached to the edges of the insulation layer 3 by membrane fasteners and plates 5. (Note: wind uplift testing of this traditional approach is shown in FIG. 4B as further explained below). As can be appreciated, the biggest weakness with this approach is that the TPO membrane 1 is only secured to the insulation layer 3 at the edges of the insulation layer (or specifically at the locations where fasteners and plates 5 are used). Unfortunately, this approach does not perform well during high winds due to the limited number of attachment points holding the TPO onto the roof. FIG. 1B illustrates TPO membrane 10 secured to insulation layer 3 using fasteners 5 (specifically a RhinoBond® anchor plate 5A connected to a mechanical fastener 5B).

FIG. 2B is an illustration of a fully adhered TPO membrane 1 installed on a roof. This is a somewhat different approach from FIG. 2A. In the approach of FIG. 2B, a bonding adhesive 6 is spread under the TPO membrane 1 and used to adhere TPO membrane onto the top of insulation layer 3. This approach has the benefit of adhesion across the entire bottom surface of the TPO membrane. Also, it has the benefit of not puncturing holes through the TPO membrane. Unfortunately, the adhesives traditionally used with such systems tend to not be as strong as desired and these roof systems also don't perform as well during high wind speed as would be desired.

Instead, a system is desired in which adhesives and strong mechanical fastening systems can be used, but still without puncturing the TPO membrane. An example of such a system is sold under the RhinoBond® brand name. In this system, an array of anchor plates are mechanically attached across the roof deck. Each anchor plate is nailed in position, and has a top surface that is covered with a heat activated adhesive. The TPO membrane is then placed over the array of anchor plates. No punctures are made through the TPO membrane. Next, after the TPO membrane has been spread over the array of anchor plates, an operator-controlled standing induction welding machine is passed over the TPO membrane. This induction welding machine has sensor coils in it that detect when it is positioned directly over an anchor plate. When the machine is in position over an anchor plate, a magnetic induction field is applied to the anchor plate. This induction field heats the anchor plate and thus causes the adhesive on the top of the anchor plate to be induction welded to the bottom surface of the TPO membrane. As such, induction welding is similar to normal in-seam mechanical fastening, but with the addition of more anchoring points in the middle of the TPO membrane.

Although this system has proven to be a good system, it would still be desirable to increase the normally achieved adhesive strengths to better bond the TPO membrane to the anchor plates. As will be explained herein, the Applicants' novel solution to this problem is to alter the formulation of the TPO membrane itself (rather than re-design or re-formulate the adhesive on the top of the anchor plates) to enhance bonding strength. It is to be understood, however, that although the present re-formulated TPO membrane could be used with any acceptable adhesives (including adhesives that are stronger than traditional RhinoBond® adhesives), the re-formulation of the TPO membrane as disclosed herein is a novel and inventive approach in and of itself.

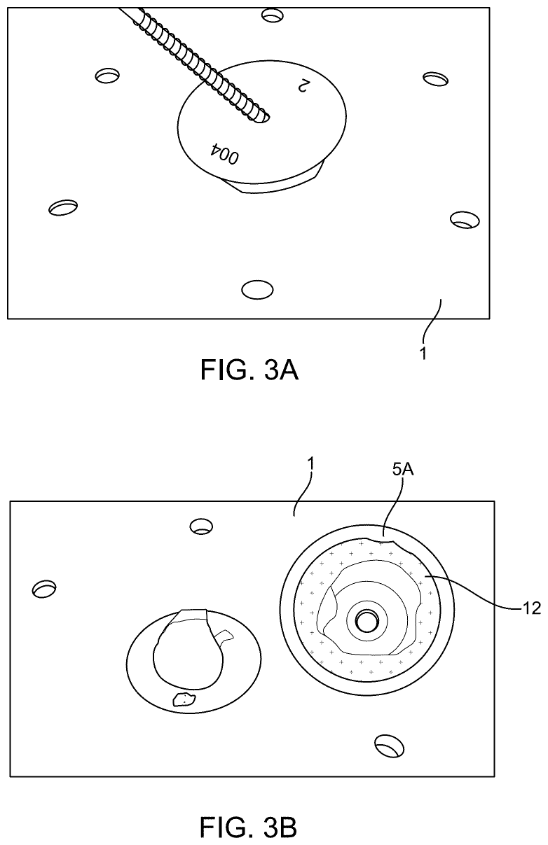

FIGS. 3A and 3B illustrate one standard method of testing the adhesion strength between the anchor plate and the TPO membrane 1. Specifically, the TPO membrane 1 (with an anchor plate 5A attached to its bottom) is flipped over as shown and the anchor plate 5A is then pulled upwardly (as seen in FIG. 3A) until it finally tears apart from the bottom of the TPO membrane (as seen in FIG. 3B). The strength of the adhesion is simply determined from the amount of force or energy required to separate the bonded anchor plate from the bottom of the TPO membrane. As can also be seen in FIG. 3B, after such a pull-test has been performed, the middle scrim layer 12 can also be torn apart (with some scrim 12 remaining on the anchor plate 5A as shown).

Further details of this RhinoBond® testing as performed by the Applicants are as follows. First, a sample of TPO membrane with a smooth surface, no defects, and a uniform thickness was collected. The sample was conditioned in a controlled environment, 23° C.±2° C. (73.4° F.±3.6° F.) and 50%±5% relative humidity, for at least 24 hours prior to testing. Three 12-inch×12-inch samples were then cut from the membrane to be tested. A HP-X Fastener was then pushed through a RhinoBond plate, with the bottom ply facing up, onto two 2″ or thicker Polyiso insulation boards. The sample membrane is then placed on top of the plate, and the induction welder is aligned on top and the activate button is switched on. The induction welding magnet is then confirmed to be cleaned, and the machine is centered over the RhinoBond plate, on top of the membrane. The magnet as kept over the sample for a minimum of 45 seconds and then removed. After the induction bonding was completed, the adhesion strength test was performed as follows.

The membrane was secured into a RhinoBond® test fixture on the bottom half of a dual tower Instron, with six hex bolts securing the membrane inside the fixture. There are two testing methods that can be carried out at this point. In a first method (corresponding to Method 1 in the Tables below), a HP-X Fastener is directly pushed through a RhinoBond® plate. In a second method, (corresponding to Method 2 in the Tables below), a washer is used between the HP-X Fastener and RhinoBond® plate to increase the contact area. Next, for either method, the force is balanced on an Instron machine and the pneumatic grip on the top half is attached to the fastener, below the tapered portion of the threads (approximately 0.5″). The test is then run, with data being recorded by the instrument, as well as visual observation of the failure mode. A typical stress and strain curve is presented in Table 7 and Table 8 below. The maximum force in the stress and strain curve is reported as the Rhinobond® adhesion in unit of Ibf or kN. The integration under the entire stress-strain curve is recorded as the Rhinobond® adhesion energy in unit of J.

FIGS. 4A and 4B illustrate standard wind uplift testing of a TPO membrane affixed to a roof. In this test, a high pressure supply of air is passed underneath the bottom of the TPO membrane (which has been attached to a roof section below). Accordingly, the TPO membrane will bow upwardly as shown. At extremely high air pressures (simulating hurricane force winds passing above the TPO), TPO membrane will tear apart and fail. The wind rating is thus determined by the air pressure/wind speed at which such failure occurs. FIG. 4A is an illustration of wind uplift testing of a TPO membrane affixed to a roof by an array of anchor plates. As can be seen, the anchor plates hold the TPO membrane down at each of the array positions of the anchor plates. For comparison, FIG. 4B is an illustration of the same wind uplift testing of a TPO membrane affixed to a roof using only traditional in-seam fastening (for example, as described above in FIG. 2A). The disadvantages of FIG. 4B/FIG. 2A approach are readily apparent since the TPO is only secured at its edges by in-seam fastening, and will thus fail at much lower wind speeds (as compared to FIG. 4A).

When the Applicants performed this testing, a sample of TPO membrane was placed on top of the wind uplift testing table with dimensions of 12′ by 24′. These membrane dimensions can vary depending on the specific test, but typically the membrane seams can run lengthwise (24′) or widthwise (12′) on the table. During these tests, RhinoBond® plates were attached to the underside of the membrane through induction welding and can be organized in a grid layout or in rows depending on the desired outputs, specifically, attachment pattern of 5′×18″ are used, i.e. row spacing of 5 feet (60 inches) are used with fastener spacing of 18 inches on center. The plate and fasteners are secured to the insulation and existing roof assembly. The testing started at a pressure of 30 psf and the pressure was held constant for one minute. If there is no failure within that minute, the pressure was then increased in 15 psf increments, with each consecutive pressure held for a minute each. The last pressure level the membrane passes for a minute without failing was designated as the wind uplift rating.

### Detailed Description of the Invention and Experimental Results Achieved

As stated above, the present system provides a TPO roofing membrane that has been specifically formulated to be ideally suited to induction welding, and in particular to induction welding of TPO to anchor plates installed underneath on the top of a building roof.

Specifically, the present TPO membrane has been formulated to have preferred amounts of specific elastomeric polymers added to either or both of the top and bottom layers of a TPO membrane. Most preferably, the elastomeric polymers that are added are either or both of polypropylene-based (C3) elastomers, combined (C3) and polyethylene-based (C2) elastomers or polyethylene-based (C2) elastomers. In various formulations disclosed herein, these elastomeric polymers may be added only to the bottom TPO layer, or more preferably to both the top and bottom TPO layers.

In preferred embodiments, the (C3) elastomers may be, but are not limited to any suitable random copolymer of propylene and ethylene with propylene content over 50%, preferably over 60% and most preferably over 70%. The preferred flexural modulus of the (C3) elastomer is 2-200 MPa, preferably 5-150 MPa and most preferably 7-100 MPa. Examples of such a (C3) elastomer would include Versify™ from Dow Chemical Company, VistaMaxx™ and Vistolon™ from ExxonMobil Corporation, Queo™ from Borealis Group, Tafmer™ from Mitsui Group, etc.

In preferred embodiments, the (C2) elastomers may be, but are not limited to any suitable random copolymer of polyethylene and alpha-olefin. Such (C2) elastomers can also be a multiblock copolymer of ethylene and alpha-olefin, for example as described in U.S. Pat. No. 7,592,397, incorporated herein by reference. The preferred flexural modulus of such a (C2) elastomer can be 2-200 MPa, preferably 5-150 MPa and most preferably 7-100 MPa. Examples of such a (C3) elastomer would be Infuse™ and Engage™ from Dow Chemical Company, Exact™ and Vistalon™ from ExxonMobil Corporation, Queo™ from Borealis Group, Tafmer™ from Mitsui Group, etc.

In preferred aspects, the polypropylene-based (C3) elastomers are added to the TPO membrane in a concentration of 5% to 70% of elastomer percent in total polymer. In more preferred aspects, the (C3) concentration would be 10% to 60%, and in most preferred aspects, the concentration would be 20% to 50%.

In other preferred aspects, the combined polypropylene-based (C3) elastomers and polyethylene-based (C2) elastomers are added to the TPO membrane in a concentration of 5% to 70% of elastomer percent in total polymer. In more preferred aspects, the (C2) concentration would be 10% to 60%, and in most preferred aspects, the concentration would be 20% to 50%.

In other preferred aspects, only (C2) polymers were added together in the above concentrations.

For comparison purposes, the top and bottom layers (i.e.: plys) of a standard TPO membrane typically have the following composition:

### Typical Roofing Membrane Ply Composition

| Top Ply | Range |
|---|---|
| Polymer | 35-83 |
| Fire retardant | 15-50 |
| UV stabilizer/antioxidant | 1-5 |
| Pigment | 1-10 |
| Bottom Ply | Range |
| Polymer | 30-83 |
| Fire retardant | 15-50 |
| UV stabilizer/antioxidant | 1-5 |
| Pigment | 1-15 |

The present Applicants have re-formulated the bottom and/or top and bottom layers of the TPO membrane to specifically improve its induction welding adhesion strength (some of the test results of which have been reproduced below).

TPO polymer used in TPO roof membranes are typically propylene polymer having flexural modulus 50-400 MPa. In the various experimental results in the Tables presented below, “Hifax™ CA10A” is the most common TPO polymer in roofing membranes and is available from LyondellBasell Industries. TPO polymer has polypropylene matrix with EP rubber as the well dispersed discrete phase. The polypropylene matrix phase is a copolymer of propylene and polyethylene. The EP rubber phase is also a copolymer of propylene and polyethylene with significantly lower flexural modulus than the polypropylene matrix phase. The TPO polymers are commonly referred to as heterophasic copolymer of polypropylene and polyethylene.

“LLDPE” (a.k.a.: Linear Low Density Polyethylene) is a hard commodity polymer, frequently used in packaging and other general applications. It is used as a carrier for other components such as flame retardants and stabilizers. LLDPE can be used to partially replace the reactor blend copolymer. LLDPE is readily available from chemical companies such as LyondellBasell Industries, Formosa Plastics Corporation, The Dow Chemical Company, Exxon Mobil Corporation, etc.

Table 1 below illustrates two experiments in which a C3 elastomer has been added to the bottom layer of the TPO. In Example 1, the bottom layer comprises 10% C3 elastomer. As can be seen, the Induction Welding Adhesion (Ibs) increased from 39 J (in the control embodiment with no C3 elastomer added) to 40 J (with 10% C3 elastomer added). In Example 2, the C3 elastomer content in the bottom layer has been increased to 15% and the Induction Welding Adhesion (Ibs) increased to 42 J.

TABLE 1

| | Comparison 1 | Example 1 | Example 2 |
|---|---|---|---|
| Hifax CA10A - top ply (%) | 53 | 53 | 53 |
| LLDPE - top ply (%) | 17 | 17 | 17 |
| Flame retardant + | 30 | 30 | 30 |
| stabilizer + pigment | | | |
| C3-based elastomer - | 0 | 0 | 0 |
| top ply (%) | | | |
| Total top ply | 100 | 100 | 100 |
| Hifax CA10A - bottom ply (%) | 58 | 48 | 43 |
| LLDPE - bottom ply (%) | 13 | 13 | 13 |
| Flame retardant + | 29 | 29 | 29 |
| stabilizer + pigment | | | |
| C3-based elastomer - | 0 | 10 | 15 |
| bottom ply (%) | | | |
| Total bottom ply | 100 | 100 | 100 |
| Lab Induction Welding | 39 | 40 | 42 |
| adhesion (J)* | | | |
| Wind uplift rating (psf) | 1-60 | 1-60 | 1-60 |

*Method 1

In the experiments shown in Table 2, a C2 elastomer was added to both the top and bottom layers of the TPO. As can be seen in Example 3, adding 15% C2 to the top and bottom layers increased the Induction Welding Adhesion (J) to 48 J. In Example 4, adding 12% C2 elastomer to the top layer and 14% C2 elastomer to the bottom layer increased the Induction Welding Adhesion to 48 J.

TABLE 2

| | Comparison 2 | Example 3 | Example 4 |
|---|---|---|---|
| Hifax CA10A - top ply (%) | 53 | 38 | 41 |
| LLDPE - top ply (%) | 17 | 17 | 17 |
| Flame retardant + | 30 | 30 | 30 |
| stabilizer + pigment | | | |
| C2-based elastomer - | 0 | 15 | 12 |
| top ply (%) | | | |
| Total top ply | 100 | 100 | 100 |
| Hifax CA10A - bottom ply (%) | 58 | 43 | 44 |
| LLDPE - bottom ply (%) | 13 | 13 | 13 |
| Flame retardant + | 29 | 29 | 29 |
| stabilizer + pigment | | | |
| C2-based elastomer - | 0 | 15 | 14 |
| bottom ply (%) | | | |
| Total bottom ply | 100 | 100 | 100 |
| Lab Induction Welding | 41 | 48 | 48 |
| adhesion (J)* | | | |
| Wind uplift rating (psf) | 1-60 | 1-60 | 1-60 |

*Method 1

In the experiments shown in Table 3, a C3 elastomer was added to both the top and bottom layers of the TPO. As can be seen in Example 5, adding 20% C3 elastomer to the top and bottom layers increased the Induction Welding Adhesion (J) from 48 J (in the control embodiment with no C3 elastomer added) to 54 J.

TABLE 3

| | Comparison 3 | Example 5 |
|---|---|---|
| Hifax CA10A - top ply (%) | 70 | 50 |
| LLDPE - top ply (%) | 0 | 0 |
| Flame retardant + stabilizer + pigment | 30 | 30 |
| C3-based elastomer - top ply (%) | 0 | 20 |
| Total top ply | 100 | 100 |
| Hifax CA10A - bottom ply (%) | 70 | 50 |
| LLDPE - bottom ply (%) | 1 | 1 |
| Flame retardant + stabilizer + pigment | 29 | 29 |
| C3-based elastomer - bottom ply (%) | 0 | 20 |
| Total bottom ply | 100 | 100 |
| Lab Induction Welding adhesion (J)* | 48 | 54 |
| Wind uplift rating (psf) | 1-60 | 1-75 |

*Method 2

In the experiments shown in Table 4, a C2 elastomer was added to both the top and bottom layers of the TPO. As can be seen in Example 6, adding 20% C2 elastomer to the top and bottom layers decreased the Induction Welding Adhesion (J) from 48 J (in the control embodiment with no C3 elastomer added) to 44 J.

TABLE 4

| | Comparison 3 | Example 6 |
|---|---|---|
| Hifax CA10A - top ply (%) | 70 | 50 |
| LLDPE - top ply (%) | 0 | 0 |
| Flame retardant + stabilizer + pigment | 30 | 30 |
| C2-based elastomer - top ply (%) | 0 | 20 |
| Total top ply | 100 | 100 |
| Hifax CA10A - bottom ply (%) | 70 | 50 |
| LLDPE - bottom ply (%) | 1 | 1 |
| Flame retardant + stabilizer + pigment | 29 | 29 |
| C2-based elastomer - bottom ply (%) | 0 | 20 |
| Total bottom ply | 100 | 100 |
| Lab Induction Welding adhesion (J)* | 48 | 44 |
| Wind uplift rating (psf) | 1-60 | 1-60 |

*Method 2

In the experiments shown in Table 5, both C2 and C3 elastomers were added to both the top and bottom layers of the TPO. As can be seen in Example 7, adding 15% C2 elastomer and 5% C3 elastomer to the top and bottom layers increased the Induction Welding Adhesion (J) from 56 J (in the control embodiment with no C2 or C3 elastomer added) to 55 J. As can be seen in Example 8, adding 10% C2 elastomer and 10% C3 elastomer to the top and bottom layers increased the Induction Welding Adhesion (J) from 56 J (in the control embodiment with no C2 or C3 elastomer added) 61 J.

TABLE 5

| | Comparison 4 | Example 7 | Example 8 |
|---|---|---|---|
| Hifax CA10A - top ply (%) | 64 | 44 | 44 |
| LLDPE - top ply (%) | 6 | 6 | 6 |
| Flame retardant + stabilizer + pigment | 30 | 30 | 30 |
| C3-based elastomer - top ply (%) | | 5 | 10 |
| C2-based elastomer - top ply (%) | 0 | 15 | 10 |
| Total top ply | 100 | 100 | 100 |
| Hifax CA10A - bottom ply (%) | 70 | 43 | 43 |
| LLDPE - bottom ply (%) | 1 | 8 | 8 |
| Flame retardant + stabilizer + pigment | 29 | 29 | 29 |
| C3-based elastomer - bottom ply (%) | | 5 | 10 |
| C2-based elastomer - bottom ply (%) | 0 | 15 | 10 |
| Total bottom ply | 100 | 100 | 100 |
| Lab Induction Welding adhesion (J)* | 56 | 55 | 61 |
| Wind uplift rating (psf) | 1-60 | 1-60 | 1-60 |

*Method 2

In the experiments shown in Table 6, a C3 elastomer was added to both the top and bottom layers of the TPO. As can be seen in Example 9, adding 30% C3 elastomer to the top and bottom layers increased the Wind Uplift Rating from 1-60 (in the control embodiment with no C3 elastomer added) to I-90.

TABLE 6

| | Comparison 5 | Example 9 |
|---|---|---|
| Hifax CA10A - top pły (%) | 57 | 27 |
| LLDPE - top ply (%) | 16 | 16 |
| Flame retardant + stabilizer + pigment | 27 | 27 |
| C3-based elastomer - top ply (%) | 0 | 30 |
| Total top ply | 100 | 100 |
| Hifax CA10A - bottom ply (%) | 57 | 27 |
| LLDPE - bottom ply (%) | 16 | 16 |
| Flame retardant + stabilizer + pigment | 27 | 27 |
| C3-based elastomer - bottom ply (%) | 0 | 30 |
| Total bottom ply | 100 | 100 |
| Lab Induction Welding adhesion (J)* | 48 | 59 |
| Wind uplift rating (psf) | 1-60 | 1-90 |

*Method 2

What is claimed is:

1. A TPO roofing membrane formulated to have enhanced induction welding properties, comprising:
a TPO roofing membrane, comprising:
a top TPO layer,
a middle scrim layer, and
a bottom TPO layer; and
elastomeric additives added to the TPO membrane, wherein the elastomeric additives increase induction welding performance of the TPO membrane.

2. The TPO roofing membrane of claim 1, wherein the added elastomeric additives are polypropylene-based (C3) elastomers.

3. The TPO roofing membrane of claim 2, wherein the polypropylene-based (C3) elastomers are added to only the bottom TPO layer.

4. The TPO roofing membrane of claim 2, wherein the polypropylene-based (C3) elastomers are added to both the top and bottom TPO layers.

5. The TPO roofing membrane of claim 2, wherein the polypropylene-based (C3) elastomers are added to the TPO membrane in a concentration of 5% to 70% of elastomer percent in total polymer.

6. The TPO roofing membrane of claim 5, wherein the polypropylene-based (C3) elastomers are added in a concentration of 10% to 60% of elastomer percent in total polymer.

7. The TPO roofing membrane of claim 5, wherein the polypropylene-based (C3) elastomers are added in a concentration of 20% to 50% of elastomer percent in total polymer.

8. The TPO roofing membrane of claim 1, wherein the added elastomeric additives are a combination of polypropylene-based (C3) elastomers and polyethylene-based (C2) elastomers.

9. The TPO roofing membrane of claim 8, wherein the combination of polypropylene-based (C3) elastomers and polyethylene-based (C2) elastomers are added to only the bottom TPO layer.

10. The TPO roofing membrane of claim 8, wherein the combination of polypropylene-based (C3) elastomers and polyethylene-based (C2) elastomers are added to both the top and bottom TPO layers.

11. The TPO roofing membrane of claim 8, wherein the combination of polypropylene-based (C3) elastomers and polyethylene-based (C2) elastomers are added to the TPO membrane in a concentration of 5% to 70% of elastomer percent in total polymer.

12. The TPO roofing membrane of claim 11, wherein the combination of polypropylene-based (C3) elastomers and polyethylene-based (C2) elastomers are added in a concentration of 10% to 60% of elastomer percent in total polymer.

13. The TPO roofing membrane of claim 12, wherein the combination of polypropylene-based (C3) elastomers and polyethylene-based (C2) elastomers are added in a concentration of 20% to 50% of elastomer percent in total polymer.

14. The TPO roofing membrane of claim 1, wherein the added elastomeric additives are polyethylene-based (C2) elastomers.

15. The TPO roofing membrane of claim 14, wherein the polyethylene-based (C2) elastomers are added only to the bottom TPO layer of the membrane.

16. The TPO roofing membrane of claim 14, wherein the polyethylene-based (C2) elastomers are added to both the top and bottom layers of the TPO membrane.

17. The TPO roofing membrane of claim 1, wherein the polypropylene-based (C3) elastomers are added to the TPO membrane in a concentration of 5% to 70% of elastomer percent in total polymer.

18. The TPO roofing membrane of claim 1, wherein the (C3) elastomer has a flexural modulus of 2-200 MPa, preferably 5-150 MPa and most preferably 7-100 MPa.

19. The TPO roofing membrane of claim 1, wherein the (C2) elastomer is a random copolymer of polyethylene and alpha-olefin.

20. The TPO roofing membrane of claim 1, wherein the (C2) elastomer is a multiblock copolymer of ethylene and alpha-olefin.

21. The TPO roofing membrane of claim 1, wherein the (C2) elastomer has a flexural modulus of 2-200 MPa, preferably 5-150 MPa and most preferably 7-100 MPa.

22. The TPO roofing membrane of claim 1, wherein the TPO membrane is induction welded to achieve an FM wind uplifting rate of 1-90 with plate and fastener spacing of 5 feet by 18 inches.
